(19) United States
(12) Patent Application Publication
(10) Pub. No.: US 2016/0102757 A1
(43) Pub. Date: Apr. 14, 2016

(54) CLOSED-LOOP MANAGEMENT OF VEHICLE DRIVELINE LASH

(71) Applicant: GM GLOBAL TECHNOLOGY OPERATIONS LLC, Detroit, MI (US)

(72) Inventors: Shaochun Ye, Northville, MI (US); Robert L. Morris, Milford, MI (US); Houchun Xia, Troy, MI (US)

(21) Appl. No.: 14/512,659

(22) Filed: Oct. 13, 2014

(51) Int. Cl. F16H 61/04; F16H 61/02; F16H 59/44

(52) U.S. Cl. CPC F16H 61/0437; F16H 59/44; F16H 61/0213; F16H 2061/0078

(57) ABSTRACT

A vehicle includes a torque device providing input torque, a transmission, an axle connected to drive wheels, a final drive unit, and a controller. The controller includes proportional-integral (PI) logic, and is programmed to determine a speed of the drive wheels and output shaft. The controller executes a method to calculate a reference output speed using the drive wheel speed and applies a calibrated offset profile to the calculated reference output speed during a lash state transition of the final drive unit, output shaft, and axle. This controls, via the PI logic, a speed difference between the output shaft and drive axle. The calibrated offset profile is higher in an early portion of the lash state to speed a transition from the lash state, and lower in a later portion of the lash state to reduce driveline clunk upon transition from the gear lash state.

### TECHNICAL FIELD

The present disclosure relates to the closed-loop management of vehicle driveline lash.

### BACKGROUND

Vehicle powertrains include torque generators such as an internal combustion engine and/or one or more electric motor generators. Driveline components in meshed engagement via splines or gear teeth have clearances as a result of manufacturing tolerances and/or component design specifications. Driveline lash is a term used in the art to describe the slight play or slack in the relative rotational positions of the various meshed driveline components resulting from such clearances. Gear lash typically occurs between a transmission output shaft and the drive axles of the vehicle, e.g., within a differential gear set or final drive unit. An impact may occur between meshed driveline components in the final drive unit when a gear lash state is exited. The resultant noise, vibration, and harshness experienced when exiting the gear lash state is referred to as driveline clunk. Dead pedal issues may also result as the slack is taken out of the driveline.

### SUMMARY

A closed-loop control methodology is disclosed herein for managing driveline gear lash in a vehicle. An output speed-based closed-loop control strategy is used to speed an exit from a gear lash state, and to temporarily freeze or maintain transmission output torque while operating such a state. As part of the present approach, a controller calculates a reference transmission output speed using speeds of drive wheels of the vehicle. An actual output speed of the transmission may be measured or estimated, e.g., via a state machine. The controller then adds a calibrated offset profile to the reference output speed during a lash transition. The calibrated offset, which may have two or more discrete stages, creates an additional speed difference between the output shaft of the transmission and the drive wheels. Lash angle is typically large during an early stage of lash transition, and so the offset profile is set to a higher relative level early in the lash transition to shorten the amount of time operating in the lash state. When the lash transition approaches its end, the offset profile is set to a lower level to reduce driveline clunk. Since the output speed tracks the reference, the relative speed difference between the output shaft and the drive axle or wheels will be small when an impact occurs between meshed gears of the final drive unit. Proportional-integral (PI) control may be used by the controller to ensure, via the integral (I) term of PI control, that the output speed tracks the calculated reference without the vehicle getting stuck in the lash state for a prolonged period of time.

A vehicle according to a possible embodiment includes an engine, a transmission having an output shaft, an axle connected to a set of drive wheels, a final drive unit, and a controller. The final drive unit is in meshing engagement with the axle and the output shaft. The controller having proportional-integral (PI) logic, wherein the controller is programmed to determine a speed of the drive wheels and of the output shaft. The controller also calculates a reference output speed using the drive wheel speed and applies a calibrated offset profile to the calculated reference output speed at a transition from a gear lash state of the final drive unit and the axle. The controller thereby controls, via the PI logic, a speed difference between the output shaft and the drive axle during the lash state. The calibrated offset profile is set to a higher relative level at an early portion of the lash state to speed a transition from the lash state, and to a lower relative level at a later portion of the lash state to reduce driveline clunk upon transition from the lash state.

The calibrated offset profile may include a plurality of discrete stages, e.g., at least a first and a second stage, or additional stages in other embodiments.

The above features and advantages and other features and advantages of the present disclosure will be readily apparent from the following detailed description of the preferred embodiments and best modes for carrying out the present disclosure when taken in connection with the accompanying drawings and appended claims.

### BRIEF DESCRIPTION OF THE DRAWINGS

FIG. 1 is a schematic illustration of an example vehicle having a controller programmed to control driveline gear lash as set forth herein.

FIG. 2 is a logic flow diagram describing example lash management control logic of the controller shown in FIG. 1.

FIG. 3 is a time plot of vehicle parameters used in the control of driveline lash via the controller shown in FIG. 1, with time depicted on the horizontal axis and amplitude depicted on the vertical axis.

### DETAILED DESCRIPTION

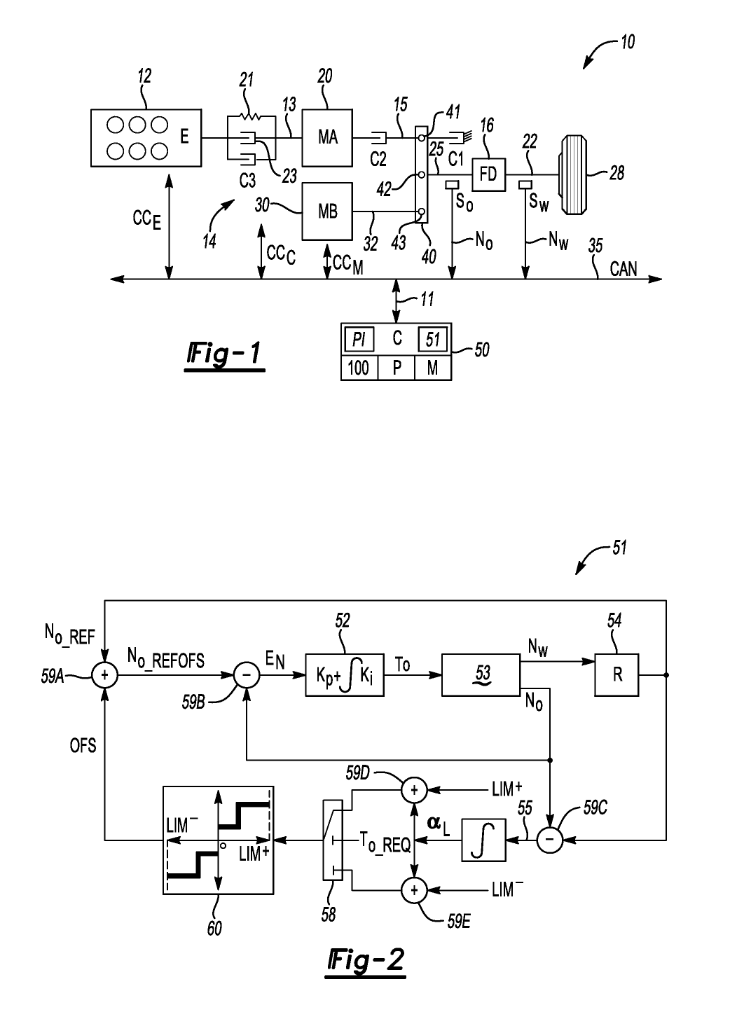

Referring to the Figures, a vehicle 10 is shown in FIG. 1 having an internal combustion engine (E) 12, a transmission 14, and a controller (C) 50. The vehicle 10 as shown in a possible non-limiting example configuration is a strong hybrid electric vehicle. The transmission 14 is connected to or includes one or more sources of input torque, including the engine 12 and a first and second electric traction motor 20 and 30 (MA and MB, respectively) in the embodiment of FIG. 1. Fewer or additional electric traction motors may be used as part of the transmission 14. The vehicle 10 may also be configured as a conventional vehicle having no traction motors.

The controller 50 includes a processor P and memory M, with the controller 50 communicating with the vehicle 10 via control signals (arrow 11) over a network 35, shown in FIG. 1 as an example controller area network (CAN) bus. The controller 50 may be a digital computer generally comprising a microprocessor or central processing unit, read only memory (ROM), random access memory (RAM), electrically programmable read only memory (EPROM), high speed clock, analog to digital (A/D) and digital to analog (D/A) circuitry, and input/output circuitry and devices (I/O) and appropriate signal conditioning and buffer circuitry.

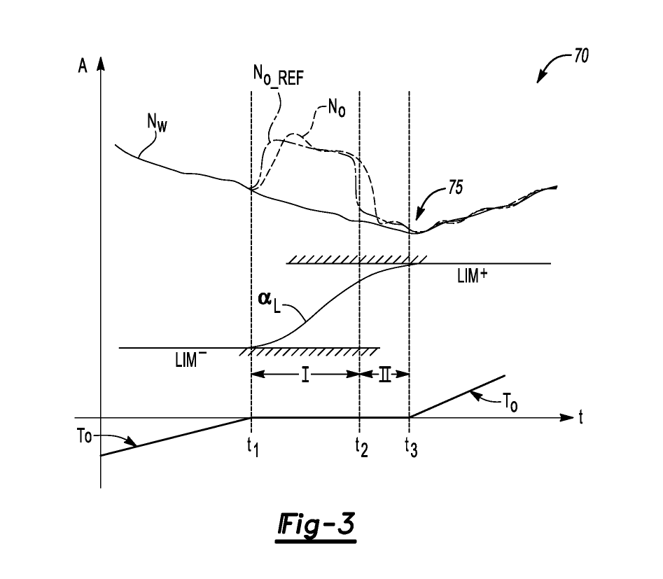

The controller 50 is specially programmed to execute a closed-loop control strategy for managing driveline lash occurring during a transition from a gear lash state. As explained below with reference to FIGS. 2 and 3, the controller 50 uses proportional-integral (PI) control logic and a calibrated offset profile to speed up a lash transition while minimizing the severity of perceptible driveline clunk. The output speed-based PI control steps also ensure that, unlike certain active damping-based control approaches, the vehicle 10 of FIG. 1 cannot be stuck in a lash state for a prolonged period, thus avoiding dead pedal issues common to lash transition and open-loop control techniques.

The vehicle 10 may include various powertrain elements such as an input damper assembly having a spring 21, a friction clutch 23, and a bypass clutch C3. The vehicle 10 may also include a planetary gear set 40 having first, second, and third nodes 41, 42, and 43, respectively, e.g., sun gear, ring gear, and carrier member in no particular order. In such an embodiment, a crankshaft 13 of the engine 12 may be connected to the first electric traction motor 20, which in turn may be connected to the first node 41 of the planetary gear set 40 via a clutch C2 and an interconnect member 15. The first node 41 may be selectively connected to a stationary member of the transmission 14 via a brake C1. Likewise, the second electric traction motor 30 may be directly connected to the third node 43 via an interconnecting member 32.

The second node 42 may be connected via a transmission output shaft 25 to a final drive unit (FD) 16, e.g., one or more differential gear sets. The final drive unit 16 is in meshed engagement with a drive axle 22 and the output shaft 25, with the drive axle 22 connected to drive wheels 28. Other powertrain configurations may be envisioned utilizing the final drive unit 16 and axle 22/drive wheels 28 and experiencing the same type of driveline lash addressed herein.

The controller 50 of FIG. 1 is in communication with the various powertrain elements via control signals, including engine control signals (arrow CC_{E}), clutch control signals (arrow CC_{C}) and motor control signals (arrow CC_{M}), all of which are known in the art. The controller 50 is shown as a unitary control device, but may be embodied in practice as multiple control modules, e.g., an engine control module, transmission control module, motor control module, and the like.

As part of the method 100, the controller 50 receives or otherwise determines input signals as part of the control signals (double headed arrow 11), including an actual transmission output speed (arrow N_{O}), e.g., as estimated via a state machine of the controller 50 as is known in the art or as directly measured and transmitted by a transmission output speed sensor (S_{O}). The input signals also include wheel speeds (arrow N_{W}), which may be calculated or measured and transmitted by a wheel speed sensor (S_{W}). Operation of the controller 50 with respect to managing a lash transition via lash management control logic 51 will now be explained with reference to FIGS. 2 and 3.

Referring to FIG. 2, the lash management control logic 51 noted above is shown schematically for illustrative simplicity. As noted immediately above, the controller 50 of FIG. 1 receives or otherwise determines the actual output speed (arrow N_{O}) and wheel speed (arrow N_{W}), for instance from the speed sensors S_{O} and S_{W}, respectively, which are collectively represented in FIG. 2 as a plant block 53. The plant block 53, in other words, represents the actual measured speeds of the physical plant, in this instance the vehicle 10 shown in FIG. 1. The wheel speed (arrow N_{W}) is fed into a ratio block (R) 54 which applies the known gear ratio of the final drive unit 16 of FIG. 1. Ratio block (R) ultimately generates a reference transmission output speed (N_{O}_{_}_{REF}), i.e., NW·R=N_{O}_{_}_{REF}F, and transmits the same to summation nodes 59A and 59C as shown in FIG. 2. The other output value from the plant block 53 is the actual output speed (arrow N_{O}), which is fed into a summation node 59B and the summation node 59C.

At summation node 59A, the reference transmission output speed (N_{O}_{_}_{REF}) is added to a calibrated offset (OFS), for instance from a 2-stage offset block 60 as described below, in order to calculate an offset reference value (N_{O}_{_}_{REFOFS}) which is then fed into summation node 59B. At summation node 59B, the output speed (N_{O}) from the plant block 53 is subtracted from the calculated offset reference value (N_{O}_{_}_{REFOFS}) to determine a speed error E_{N}. The speed error (E_{N}) is then received as an input by a proportional-integral (PI) block 52, e.g., part of the PI logic noted above, which processes the speed error to determine the output torque (arrow T_{O}) to command from the powertrain shown in FIG. 1, doing so via the plant block 53 and acting on the various torque systems shown in FIG. 1 and described above.

Summation node 59C of FIG. 2 subtracts the output speed (N_{O}) from the reference value (N_{O}_{_}_{REF}) to determine a closure rate (arrow 55), i.e., a rate at which the output speed (N_{O}) is approaching the reference value (N_{O}_{_}_{REF}). This rate is received by an integrator block 56, again part of the PI logic noted above, which determines the present lash angle (α_{L}), which is the angle between meshed powertrain elements defining the lash. The controller 50 of FIG. 1 the applies respective positive and negative limits (LIM+, LIM−) to the lash angle (α_{L}) at summation nodes 59D and 59E, respectively, and passes the information along with an output torque request (T_{O}_{_}_{REQ}) to a logic switch 58 as shown. The output torque request (T_{O}_{_}_{REQ}) is passed to the offset block 62 if it falls between the positive and negative limits. Otherwise, one of the calibrated limits is passed.

With respect to operation of the offset block 62 and the calibrated limits, FIG. 3 provides a set of example traces 70 to further illustrate this point for an example 2-stage offset design. Amplitude (A) is plotted on the vertical axis and time (t) on the horizontal axis. Trace N_{W} represents wheel speed, as noted above, and is shown as slowing between t₀ and t₂ as the vehicle 10 slows in reverse and output torque (T_{O}), here negative, is reduced to zero. At t₁ the lash angle (α_{L}) begins to increase but is limited via the positive and negative limits as explained above.

As the lash state is entered at t₁, the generated offset reference (N_{O}_{_}_{REF}) issued as a control target to be followed or tracked, via closed-loop control of the controller 50, by the output speed (N_{O}). Stage I of the offset block 62 of FIG. 2 occurs between t₁ and t₂ at an early portion of the lash state, wherein a relatively high reference (N_{O}_{_}_{REF}) is passed to speed the transition or exit from a lash state. Toward the end of or a latter portion of the lash state beginning at t₂, the controller 50 of FIG. 1 switches to stage II of the example 2-stage offset block 62 of FIG. 2 and closes the lash angle (α_{L}) at a slower rate, e.g., less than 50% of the rate applied earlier in the lash state transition, thereby “fine tuning” the feel of the lash transition at the moment the driveline exits the lash state. The second stage continues until t₃, with the impact speed at lash transition indicated generally by arrow 75.

The length of the second stage between t₂ and t₃ is determined by the desired control response. That is, too much delay may be perceptible to the driver as lag, while too little delay could still result in a perceptible clunk. At t₃ the output torque (T_{O}) is again permitted to slowly rise of its own accord in response to driver request torque. Likewise, the actual applied limits at stages I and II of the offset block 62 shown in FIG. 2 may vary with the design to provide the desired feel. Alternative embodiments may include more than two discrete stages or staged patterns that are not stepped, e.g., a ramped offset that rises at a calibrated slope to the respective positive and negative limits, a curve, or other suitable shape. However, the use of a 2-stage approach lends itself to programming simplicity while providing the desired speed and noise reducing response during lash transition.

While the best modes for carrying out the disclosure have been described in detail, those familiar with the art to which this disclosure relates will recognize various alternative designs and embodiments for practicing the disclosure within the scope of the appended claims.

1. A vehicle comprising:
a torque device providing an input torque;
a transmission having an output shaft, wherein the transmission receives the input torque from the torque device and delivers an output torque via the output shaft;
a drive axle connected to a set of drive wheels;
a final drive unit in meshing engagement with the axle and the output shaft; and
a controller having proportional-integral (PI) logic that ensures that the output speed tracks a reference, the relative speed difference between the output shaft and the drive axle or wheels will be small when an impact occurs between meshed gears of the final drive unit, wherein the controller is programmed to determine a speed of the drive wheels and of the output shaft, calculate a reference output speed using the drive wheel speed, limit a lash angle of meshed elements of the final drive unit, the drive axle, and the output shaft during a gear lash state of the final drive unit, the output shaft, and the axle by applying positive and negative limits to the lash angle, and apply a calibrated offset profile to the calculated reference output speed during a transition from the gear lash state to thereby control, via the PI logic, a speed difference between the output shaft and the drive axle, and wherein the calibrated offset profile is set to a higher relative level at an early portion of the gear lash state to speed a transition from the gear lash state having the limited lash angle, and to a lower relative level at a later portion of the lash state while freezing or maintaining the output torque from the transmission while in the gear lash state to thereby reduce driveline clunk upon transition from the gear lash state.

2. The vehicle of claim 1, wherein the controller uses the PI logic to ensure that the speed of the output shaft tracks the calculated reference output speed while in the gear lash state.

3. The vehicle of claim 1, wherein the calibrated offset profile includes a plurality of discrete stages.

4. The vehicle of claim 3, wherein the calibrated offset profile includes only two discrete stages.

5. The vehicle of claim 1, further comprising a speed sensor positioned with respect to one of the axle and the drive wheels, wherein the controller is operable to determine the speed of the drive wheels by receiving an actual speed of the drive wheels from the speed sensor.

6. The vehicle of claim 1, further comprising a transmission output speed sensor positioned with respect to the output shaft and operable to measure an actual output speed of the transmission, wherein the controller is operable to determine the output speed by receiving the measured actual speed of the transmission from the transmission output speed sensor.

7. A method for controlling gear lash in a vehicle, the method comprising:
determining a speed of a set of drive wheels and a transmission output shaft of a vehicle having a final drive unit, wherein the drive wheels are connected to a drive axle;
calculating, via a controller, a reference output speed using the drive wheel speed;
limiting a lash angle of meshed elements of the final drive unit, the output shaft, and the drive axle during a gear lash state of the final drive unit, the output shaft, and the drive axle by applying positive and negative limits to the lash angle; and
applying a calibrated offset profile to the calculated reference output speed during a transition from the gear lash state to thereby control, via proportional-integral logic of the controller, a speed difference between the output shaft and the drive axle, including setting the calibrated offset profile to a higher relative level at an early portion of the gear lash state to speed a transition from the gear lash state, and to a lower relative level at a later portion of the lash state while freezing or maintaining the output torque of the transmission in the gear lash state to thereby reduce driveline clunk upon transition from the gear lash state.

8. The method of claim 7, further comprising using the proportional-integral logic to ensure that the speed of the output shaft tracks the calculated reference output speed while in the gear lash state.

9. The method of claim 7, wherein applying the calibrated offset profile includes applying different offset values in a plurality of discrete stages.

10. The method of claim 9, wherein the calibrated offset profile includes only two of the discrete stages.

11. The method of claim 7, wherein determining the speed of the drive wheels includes measuring an actual speed of the drive wheels via a speed sensor.

12. The method of claim 7, wherein determining the transmission output speed includes receiving a measured actual speed of the transmission via a transmission output speed sensor.

13. A method for controlling gear lash in a vehicle having a transmission and a final drive unit, the method comprising:
measuring, via a wheel speed sensor, a speed of a set of drive wheels connected to a drive axle of the vehicle;
measuring, via a transmission output speed sensor, an actual speed of an output shaft of the transmission;
calculating, via a controller, a reference output speed using the measured speed of the drive wheels;
limiting a lash angle of meshed elements of the final drive unit, the output shaft, and the drive axle during a gear lash state of the final drive unit, the output shaft, and the drive axle by applying positive and negative limits to the lash angle; and
applying a calibrated 2-stage offset profile to the calculated reference output speed during a transition from a gear lash state of a final drive unit, the output shaft, and the drive axle to thereby control, via proportional-integral logic of the controller, a speed difference between the output shaft and the drive axle, including:
applying the 2-stage calibrated offset profile at a first level at an early portion of the lash state sufficient for speeding a transition from the gear lash state having the limited lash angle;
freezing or maintaining an output torque of the transmission while in the gear lash state; and
reducing the first level to a second level at a later portion of the lash state to thereby reduce driveline clunk upon transition from the gear lash state.

14. The method of claim 13, wherein the second level is less than 50% of the first level.
